(19) United States
(12) Patent Application Publication
(10) Pub. No.: US 2005/0186438 A1
(43) Pub. Date: Aug. 25, 2005

(54) Electrically conductive thermoplastic compositions

(76) Inventors: Gregory R. Alms, Hockessin, DE (US); Toshikazu Kobayashi, Chadds Ford, PA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/943,527

(22) Filed: Sep. 18, 2004

Related U.S. Application Data
(60) Provisional application No. 60/505,403, filed on Sep. 24, 2003.
(60) Provisional application No. 60/606,055, filed on Aug. 31, 2004.

(51) Int. Cl. B32B 27/36; C08L 67/00

(52) U.S. Cl. 428/480; 525/437

(57) ABSTRACT

Thermoplastic compositions containing reinforcing agents or fillers and carbon black, and made by a specific procedure are described. In certain instances when the reinforcing agents or fillers are more restricted, and other ingredients are present, electrically conductive compositions with very smooth surfaces, and suitable for auto panels and other uses wherein the part may be painted, are described. Also described are the processes of making such compositions, especially when a conductive filler is carbon black. Such compositions are useful for items such as appliance parts, automotive body panels, power tool housings, and electrical and electronic housings.

### CROSS REFERENCE TO RELATED APPLICATIONS

This application claims priority of U.S. Provisional Application No. 60/505,403, filed Sep. 24, 2003 and U.S. Provisional Application No. 60/606,055, filed Aug. 31, 2004.

### FIELD OF THE INVENTION

A polyester composition comprising specified amounts of certain reinforcing agents, specified electrically conductive fillers, a toughening agent, and optionally a liquid crystalline polymer, is useful for making parts requiring a smooth surface and especially those which will be painted, for instance for automotive body panels and appliance parts such as handles and housings. Also disclosed are methods for making electrically conductive or electrostatically paintable thermoplastic compositions.

### TECHNICAL BACKGROUND

One of the challenges in replacing metal parts with plastics is producing plastic parts with good looking (smooth) surfaces, and/or whose surfaces can be coated (painted) to have a glossy smooth appearance. This, often coupled with the need for certain minimum levels of toughness and/or heat resistance, has presented a challenge, especially in using polymers and other ingredients that are relatively inexpensive. Thermoplastics of various types have been tried in such applications, and have been successfully used in some instances, and have the advantage of being reusable (for example scrap) and often are tougher than thermoset polymers. However in uses where high resistance to two or more environmental stresses are needed, improved compositions are still needed.

For instance, a particularly challenging type of part is an automotive body panel, such as a fender. These parts must be precisely molded to close dimensional tolerances so they will fit properly on the automobile, they must be tough enough to resist mechanical/impact damage, and they must have a very smooth surface so (usually) when they are painted they have a good surface appearance (sometimes called a “Class A” surface). In addition it is preferred that they have enough heat resistance so that they can withstand the temperatures (sometimes as high as 200° C., and for as long as 30 minutes) in an automotive paint bake oven without excessively sagging, warping, or otherwise deforming. While these parts can be painted separately at lower temperatures and then later attached to the body after painting (so called off line painting) such a process adds significant cost to the vehicle assembly process, and it is preferred from an economic standpoint to paint these parts on the regular paint line. Color matching of parts painted in two different processes may be difficult. These parts also need to have a minimum level of stiffness and fatigue resistance to stresses that are repeatedly encountered in normal use.

Other appearance parts may not require this extreme temperature resistance, but often require the other attributes mentioned above.

In car body building, metal parts are increasingly being replaced by plastic parts and not just to save weight; examples include fenders, hoods, doors, lift-up tailgates, trunk lids, tank caps, bumpers, protective moldings, side panels, body sills, mirror housings, handles, spoilers and hub caps. From the external appearance, for example with respect to color tone, gloss and/or short-wave and long-wave structure, the surfaces of the coated plastic parts for the observer should not differ, or should differ only slightly from the coated metal surfaces of a car body. This applies, in particular, to plastic parts which are constructed with as small a joint width as possible to and in particular also in the same plane as adjacent metal parts, since visual differences are particularly striking there.

There are three different approaches to the production of coated car bodies assembled from metal and plastic parts in a mixed construction:

1. The method known as the off-line process, in which the metal car body and the plastic parts are coated separately and then assembled.

The drawback of the off-line process is its susceptibility to lack of visual harmonization of the coated metal and plastic surfaces, at least in cases where coated plastic parts and coated metal parts are subjected to direct visual comparison for reasons of construction, for example, owing to the virtually seamless proximity of the coated parts and/or arrangement of the coated parts in one plane.

A further drawback is the necessity of operating two coating processes.

2. The method known as the in-line process in which the metal body already provided with an electrodeposition coating as a primer and the uncoated plastic parts or the plastic parts optionally only provided with a plastic primer are assembled and provided with one or more further coating layers in a subsequent common coating process.

The drawback of the in-line process is the assembly step inserted into the coating process as an interruptive intermediate step which also involves the risk of introducing dirt into the further coating process.

3. The method known as the on-line process, in which the uncoated body parts made of metal and the uncoated plastic parts or the plastic parts optionally only provided with a plastic primer are assembled into a body constructed in a mixed construction and then passed through a common coating process including electrodeposition coating, wherein naturally only the electrically conductive metal parts are provided with an electrodeposition coating, while all the coating layers to be applied subsequently are applied both to the electrodeposition coated metal parts and to the plastic parts.

The on-line process is particularly preferred as it clearly separates the body base shell construction and the coating process and allows an undisturbed coating sequence. Basically only adequately heat-resistant and simultaneously heat deformation-resistant plastics materials are suitable for the particularly preferred on-line process, since high temperatures are used in the drying of the electrodeposition coating. Plastic parts made of previously available fiber-reinforced thermoplastics, for example, are at best conditionally suitable, since the coated surfaces do not have an adequate high visual harmonization with the coated metal surfaces and, in particular, are not up to the high standards required by car manufacturers.

In addition for some painting processes such as electrostatically aided painting processes, it is desired that the part to be painted be more electrically conductive than typical thermoplastic compositions (TCs). In some instances the part may be coated with an electrically conductive primer, but this is an extra step in manufacture. It is known that adding sufficient amounts of electrically conductive fillers (ECFs) to (some) TCs renders these compositions more electrically conductive (less electrically resistant), although the increase in conductivity depends on the type and amount of ECF used, the actual makeup of the TC, and the degree of dispersion of the ECF in the TC. Many ECFs are also known to affect the other properties of the TC, such as toughness and surface qualities, so these must also be taken into account when making such compositions. Thus methods for more efficiently increasing the electrical conductivity of such compositions, while causing as little deterioration of other properties as possible, are sought.

U.S. Pat. No. 5,965,655 describes compositions containing thermoplastics such as polyalkylene terephthalates and fillers such as wollastonite having specified particles size ranges which can have “Class A” surfaces. Specific compositions also containing LCPs, and/or plasticizers, and/or toughening agents are not disclosed.

U.S. Pat. No. 6,221,962 describes compositions containing an LCP, a toughening agent with reactive functional groups, and a thermoplastic. The presence of specific compositions containing plasticizers and fillers is not mentioned.

U.S. Pat. No. 4,753,980 describes polyester compositions containing certain toughening agents. The use of LCPs and/or fillers with the present specific size ranges is not mentioned in the patent.

U.S. Patent Re32,334 describes a crystallization initiation system for poly(ethylene terephthalate) (PET) which involves the use of certain compounds containing metal cations and plasticizers for the PET. No mention is made of LCPs, and/or fillers with specific size ranges, in the compositions.

U.S. Pat. Nos. 4,438,236 and 4,433,083 describe blends of LCPs with various thermoplastics. No specific mention is made of compositions containing polyesters and/or plasticizers and/or fillers which have particular size ranges.

U.S. Pat. No. 5,484,838 describes certain compositions containing conductive carbon black. The compositions described herein are not disclosed.

### SUMMARY OF THE INVENTION

This invention concerns a first composition, comprising,
(a) at least about 40 weight percent of one or more isotropic polyester (IPE) with a melting point (MP) of about 100° C. or more;
(b) 0.0 to about 20 weight percent of a liquid crystalline polymer (LCP) whose melting point is at least 50° C. higher than a cold crystallization point (CCP) of said isotropic polyester, or if said isotropic polyester has no cold crystallization point said melting point of said liquid crystalline polymer is 150° C. or higher;
(c) about 1.0 to about 35 weight percent of a reinforcing agent with an average aspect ratio of about 2.5 or more, and whose average longest dimension is 20 μm or less;
(d) about 3 to about 30 weight percent of a polymeric toughening agent which contains functional groups reactive with said isotropic polyester; and
(e) a sufficient amount of an electrically conductive filler so that said composition has one or more of a surface resistivity of said composition is about 10¹² ohm/sq or less, a static dissipative time of about 10 seconds or less, and a paint conductivity of about 90 or more, and wherein an average longest dimension of said electrically conductive filler is 20 μm or less;
and wherein all percents by weight are based on the total of all ingredients in the composition.

This invention also concerns a first process for the manufacture of a composition comprising:
(a) at least about 40 weight percent of one or more isotropic polyester (IPE) with a melting point (MP) of about 100° C. or more;
(b) 0.0 to about 20 weight percent of a liquid crystalline polymer (LCP) whose melting point is at least 50° C. higher than a cold crystallization point (CCP) of said isotropic polyester, or if said isotropic polyester has no cold crystallization point said melting point of said liquid crystalline polymer is 150° C. or higher;
(c) about 1.0 to about 35 weight percent of a reinforcing agent with an average aspect ratio of about 2.5 or more, and whose average longest dimension is 20 μm or less;
(d) about 3 to about 30 weight percent of a polymeric toughening agent which contains functional groups reactive with said isotropic polyester; and
(e) a sufficient amount of an electrically conductive filler so that said composition has one or more of a surface resistivity of said composition is about 10¹² ohm/sq or less, a static dissipative time of about 10 seconds or less, and a paint conductivity of about 90 or more, and wherein an average longest dimension of said electrically conductive filler is 20 μm or less; and wherein all percents by weight are based on the total of all ingredients in the composition;
said process comprising the steps of:
(a) in a first mixing step mixing materials comprising said isotropic polyester and said polymeric toughening agent to form an intermediate composition; and then
(b) in a subsequent mixing step by introducing and mixing said carbon black, and optionally other ingredients, into said intermediate composition while said intermediate composition is molten.

This invention also concerns a second process for the manufacture of an electrically conducting thermoplastic composition, comprising, introducing and mixing carbon black into a material comprising a molten thermoplastic polymer, to form said thermoplastic composition.

This invention concerns a third process for coating a substrate assembled from metal parts and at least one thermoplastic part, with visible metal and thermoplastic surfaces, comprising the successive steps:
(1) partially or completely electrodeposition coating the substrate, removing non-deposited electrodeposition coating agent from the substrate and thermally cross-linking the deposited electrodeposition coating and thereby forming an electrodeposition coating primer on the metal surfaces,
(2) application and curing of at least one additional coating at least on all the visible metal and thermoplastic surfaces, at least some of the thermoplastic parts making up the visible thermoplastic surfaces of the substrate having the first composition described above.

Also disclosed are the novel individual steps of the third process described above, auto bodies and other automotive parts and other appearance parts comprising the first composition above, whether that composition is coated or uncoated.

### DETAILS OF THE INVENTION

Herein certain terms are used, and some of them are defined below.

By a “liquid crystalline polymer” is meant a polymer that is anisotropic when tested using the TOT test or any reasonable variation thereof, as described in U.S. Pat. No. 4,118,372, which is hereby included by reference. Useful LCPs include polyesters, poly(ester-amides), and poly(ester-imides). One preferred form of polymer is “all aromatic”, that is all of the groups in the polymer main chain are aromatic (except for the linking groups such as ester groups), but side groups which are not aromatic may be present.

By “isotropic” herein is meant a polymer which is isotropic when tested by the TOT test, described above. LCPs and isotropic polymers are mutually exclusive species.

“Visible substrate surfaces” means outer substrate surfaces which are directly visually accessible, in particular visible to an observer, for example, without the aid of special technical or visual aids (normal spectacles may be used).

By an “IPE” is meant a condensation polymer which is isotropic and in which more than 50 percent of the groups connecting repeat units are ester groups. Thus IPEs may include polyesters, poly(ester-amides) and poly(ester-imides), so long at more than half of the connecting groups are ester groups. Preferably at least 70% of the connecting groups are esters, more preferably at least 90% of the connecting groups are ester, and especially preferably essentially all of the connecting groups are esters. The proportion of ester connecting groups can be estimated to a first approximation by the molar amounts of monomers used to make the IPE.

Unless otherwise noted, melting points are measured by ASTM Method D3418, using a heating rate of 10° C./min. Melting points are taken as the maximum of the melting endotherm, and are measured on the first heat. If more than one melting point is present the melting point of the polymer is taken as the highest of the melting points. Except for LCPs, a melting point preferably has a heat of fusion of at least 3 J/g associated with that melting point.

Unless otherwise noted average particle sizes (for example of the reinforcing agent or ECF) are measured by optical microscopy at 700× magnification using computer analysis of the resulting images to calculate the average (sometimes also called the number average) length and width of the particles. It is possible that if the primary particle size of the material is very small primary particles may not be seen individually, but rather aggregates and/or agglomerates may be seen. If it is suspected that the primary particles are very small, this may be checked by a high magnification method such as scanning electron microscopy (SEM). If such small primary particles are found, analysis of particle size at 700× may not be needed if it is clear the average primary particle size is much below the required maximum. The aspect ratio is the ratio of the longest dimension of a particle divided by the shortest dimension of the particle. The average aspect ratio is measured by dividing the average length by the average width of the particles as determined by optical microscopy, or if needed by another method such as SEM. Types of particles which may have the requisite aspect ratios include needle-like particles, fibers, fibrids, fibrils, and platy particles.

By a “CCP” is meant a value determined as follows. The “pure” (no other ingredients in the composition except small amounts of materials such as an antioxidant which may be needed to stabilize the IPE in the injection molding process and/or a lubricant needed for improving mold release) IPE is injection molded into a 1.59 mm ( 1/16″) thick plaque using a mold whose temperature is 50° C. An appropriate sized sample (for the instrument) from the plaque is placed in a Differential Scanning Calorimeter and heated from ambient temperature (approximately 20-35° C.) at a rate of 10° C./min. The peak of the exotherm from crystallization of the IPE while it is being heated is taken as the CCP. The IPE has no CCP if there is no crystallization exotherm below the melting point of the IPE. Alternatively, the CCP can be determined by the “Quick Quench” method where the sample is fully melted by heating in a DSC pan to above the melting point of the material and immediately cooling the material in the DSC pan by dropping it into a dry/acetone or liquid nitrogen bath. The DSC is then run as above.

By “all percents by weight are based on the total of all ingredients in the composition” is meant that these percent are based on the total amount of (a), (b), (c), (d) and (e) present plus any other ingredients present in the composition.

The IPE used may be any IPE with the requisite melting point. Preferably the melting point of the IPE is about 150° C. or higher, more preferably about 200° C. or higher, especially preferably about 220° C. or higher, and very preferably about 240° C. or higher. Polyesters (which have mostly or all ester linking groups) are normally derived from one or more dicarboxylic acids and one or more diols. In one preferred type of IPE the dicarboxylic acids comprise one or more of terephthalic acid, isophthalic acid and 2,6-naphthalene dicarboxylic acid, and the diol component comprises one or more of HO(CH₂)ₙOH (I), 1,4-cyclohexanedimethanol, HO(CH₂CH₂O)ₘCH₂CH₂OH (II), and HO(CH₂CH₂CH₂CH₂O)ₙCH₂CH₂CH₂CH₂OH (III), wherein n is an integer of 2 to 10 μm on average is 1 to 4, and is z an average of about 7 to about 40. Note that (II) and (III) may be a mixture of compounds in which m and z, respectively may vary and hence since m and z are averages, they z do not have to be integers. Other diacids which may be used to form the IPE include sebacic and adipic acids. Other diols include a Dianol® {for example 2,2-bis[4-(2-hydroxyethoxy)phenyl]propane available from Seppic, S.A., 75321 Paris, Cedex 07, France} and bisphenol-A. In preferred polyesters, n is 2, 3 or 4, and/or m is 1.

By a “dicarboxylic acid” in the context of a polymerization process herein is meant the dicarboxylic acid itself or any simple derivative such as a diester which may be used in such a polymerization process. Similarly by a “diol” is meant a diol or any simple derivative thereof which can be used in a polymerization process to form a polyester.

Specific preferred IPEs include poly(ethylene terephthalate) (PET), poly(1,3-propylene terephthalate) (PPT), poly(1,4-butylene terephthalate) (PBT), poly(ethylene 2,6-napthoate), poly(1,4-cylohexyldimethylene terephthalate) (PCT), a thermoplastic elastomeric polyester having poly(1,4-butylene terephthalate) and poly(tetramethyleneether)glycol blocks (available as Hytrel® from E. I. DuPont de Nemours & Co., Inc., Wilmington, Del. 19898 USA) and copolymers of any of these polymers with any of the above mentioned diols and/or dicarboxylic acids. If more than one IPE (with the proper melting points) are present, the total of such polymers in the composition is taken as component (a). Preferably the composition contains at least about 50 weight percent component (a). If a blend of 2 or more IPEs is used, it is preferred that the IPE “fraction” of the polymer has at least one melting point which is 150° C. or more (depending on mixing conditions, if two or more IPEs are used, transesterification may take place).

Component (c) the reinforcing agent, has an average aspect ratio of about 2.5 or more, preferably about 3.0 or more, and more preferably about 4.0 or more. Oftentimes as the aspect ratio of the particles increases, the heat sag (see below) decreases and stiffness increases. The average maximum dimension is about 20 μm or less, more preferably about 15 μm or less, very preferably about 10 μm or less. A preferred minimum average longest dimension is about 0.10 μm or more, more preferably about 0.5 μm or more. Preferably less than 10% of the particles have a longest dimension of about 100 μm or more, more preferably less than 5%. Any of these ratios or dimensions may be combined with any other ratios or dimensions of the reinforcing agent, as appropriate. Surface smoothness is often improved is the particle size of the reinforcing agent is towards the small end of the range.

Useful specific reinforcing agents for component (c) include wollastonite, mica, talc, aramid fibers, fibrils or fibrids, carbon fibers, potassium titanate whiskers, boron nitride whiskers, aluminum borate whiskers, magnesium sulfate whiskers and calcium carbonate whiskers. Preferred reinforcing fillers are wollastonite, mica, talc, potassium titanate whiskers, boron nitride whiskers and aluminum borate whiskers, and especially preferred reinforcing agents are wollastonite, talc and potassium titanate whiskers. All of these specific reinforcing agents should have the appropriate dimensions as outlined above. These reinforcing agents may be coated with adhesion promoters or other materials which are commonly used to coat reinforcing agents used in thermoplastics.

Preferably the amount of reinforcing agent (c) is about 3 to about 30 weight percent of the composition, more preferably about 5 to 20 weight percent. Generally speaking the more reinforcing agent (c) in the composition the stiffer the composition will be, in many cases the heat sag (see below) will be decreased, and sometimes the surface will be rougher.

Any LCP [component (b)] may be used in this composition as long as the melting point requirement is met. Suitable LCPs, for example, are described in U.S. Pat. Nos. 3,991,013, 3,991,014 4,011,199, 4,048,148, 4,075,262, 4,083,829, 4,118,372, 4,122,070, 4,130,545, 4,153,779, 4,159,365, 4,161,470, 4,169,933, 4,184,996, 4,189,549, 4,219,461, 4,232,143, 4,232,144, 4,245,082, 4,256,624, 4,269,965, 4,272,625, 4,370,466, 4,383,105, 4,447,592, 4,522,974, 4,617,369, 4,664,972, 4,684,712, 4,727,129, 4,727,131, 4,728,714, 4,749,769, 4,762,907, 4,778,927, 4,816,555, 4,849,499, 4,851,496, 4,851,497, 4,857,626, 4,864,013, 4,868,278, 4,882,410, 4,923,947, 4,999,416, 5,015,721, 5,015,722, 5,025,082, 5,086,158, 5,102,935, 5,110,896, and 5,143,956, and European Patent Application 356,226. In many instances it is preferred that the LCP used have a relatively high melting point, preferably above about 250° C., more preferably above about 300° C., even more preferably above about 325° C., and even more preferably above about 350° C. The melting point of the LCP should not be so high however so that the temperature needed for forming and melt processing the composition will cause significant degradation of the IPE used. By significant degradation in this instance is meant sufficient degradation to cause the composition to be unsuited for the intended use.

The first composition may contain up to about 20 weight percent of the LCP, preferably about 1.0 to about 15 weight percent, and more preferably about 2.0 to about 10, and very preferably about 1.0 to about 10 weight percent. Generally speaking, as the amount of LCP is increased in the first composition, heat sag is lowered, and stiffness is increased, usually without significantly affecting surface appearance. It has also surprisingly been found that even if the melting points of a group of LCPs are well above the temperature of the heat sag test, the higher the melting point of the LCP, generally the lower (better) the heat sag is.

The polymeric toughening agent (component D) is a polymer, typically which is an elastomer or has a relatively low melting point, generally <200° C., preferably <150° C., which has attached to it functional groups which can react with the IPE. Since IPEs usually have carboxyl and hydroxyl groups present, these functional groups usually can react with carboxyl and/or hydroxyl groups. Examples of such functional groups include epoxy, carboxylic anhydride, hydroxyl (alcohol), carboxyl, isocyanato, and primary or secondary amino. Preferred functional groups are epoxy and carboxylic anhydride, and epoxy is especially preferred. Such functional groups are usually “attached” to the polymeric toughening agent by grafting small molecules onto an already existing polymer or by copolymerizing a monomer containing the desired functional group when the polymeric tougher molecules are made by copolymerization. As an example of grafting, maleic anhydride may be grafted onto a hydrocarbon rubber using free radical grafting techniques. The resulting grafted polymer has carboxylic anhydride and/or carboxyl groups attached to it. An example of a polymeric toughening agent wherein the functional groups are copolymerized into the polymer is a copolymer of ethylene and a (meth)acrylate monomer containing the appropriate functional group. By (meth)acrylate herein is meant the compound may be either an acrylate, a methacrylate, or a mixture of the two. Useful (meth)acrylate functional compounds include (meth)acrylic acid, 2-hydroxyethyl(meth)acrylate, glycidyl(meth)acrylate, and 2-isocyanatoethyl (meth)acrylate. In addition to ethylene and a difunctional (meth)acrylate monomer, other monomers may be copolymerized into such a polymer, such as vinyl acetate, unfunctionalized (meth)acrylate esters such as ethyl (meth)acrylate, n-butyl (meth)acrylate, and cyclohexyl (meth)acrylate. Preferred tougheners include those listed in U.S. Pat. No. 4,753,980, which is hereby included by reference. Especially preferred tougheners are copolymers of ethylene, ethyl acrylate or n-butyl acrylate, and glycidyl methacrylate.

It is preferred that the polymeric toughener contain about 0.5 to about 20 weight percent of monomers containing functional groups, preferably about 1.0 to about 15 weight percent, more preferably about 7 to about 13 weight percent of monomers containing functional groups. There may be more than one type of functional monomer present in the polymeric toughener. It has been found that toughness of the first composition is increased by increasing the amount of polymeric toughener and/or the amount of functional groups. However, these amounts should preferably not be increased to the point that the composition may crosslink, especially before the final part shape is attained. Preferably there is about 5 to about 25 weight percent of the polymeric toughener in the composition, more preferably about 10 to about 20 weight percent. A mixture of 2 or more polymeric tougheners may be used in the same composition. At least one must contain reactive functional groups, but the other(s) may or may not contain such functional groups. For instance, tougheners which do not contain functional groups include ethylene-n-butyl acrylate copolymer, ethylene/n-butyl acrylate/carbon monoxide copolymer and a linear low density polyethylene such as Engage® 8180 (available from the DuPont-Dow Elastomers, Wilmington, Del. USA).

The ECF may be any filler (or fillers) which is electrically conductive, and such materials are well known and used in the art. These include carbon in various forms such as carbon black, carbon fiber, graphite, carbon nanotubes, buckminsterfullerenes, and carbon spheres. Carbon, especially carbon black, is a preferred form of an ECF. Some grades of carbon blacks, such as Ketjenblack® EC600JD, Printex® XE2 (Degussa Corp., Parsippany, N.J. 07054 USA), and Raven® and Conductex® 975 Ultra (Colombian Chemicals Co., Marietta, Ga. 30062 USA), are made to have especially high electrical conductivities, and these are an especially preferred form of carbon black. Other ECFs include metal powders, metal wires, fibers or filaments, various metal coated fillers such as carbon fiber and minerals, and polyanilines. ECFs, if they have the requisite particle size properties, are also included in reinforcing fillers, so that the ECF may be all or part of the reinforcing filler, as well as the ECF. If the ECF is also a reinforcing filler, its concentration is only counted once for the purpose of totaling ingredients in the composition.

So long as the ECF material(s) meet the particle size limitation for the ECF, they may be used in (first) compositions where smooth surfaces and/or high DOI painted surfaces are needed. The ECF particle size is measured in the compositions described herein, that is after all of the ingredients have been mixed together to form the composition. If a smooth surface is not needed, the above particle size limitation does not apply. In the first composition, preferred particle sizes (these are primary particle sizes) for component (c), above, are also preferred for the ECF.

The amount of ECF needed to achieve a desired electrically conductivity, including static dissipation, or electrostatic paintability depends on a number of factors. Among these are the specific material used in the TC, the specific ECF used, the degree of dispersion of the ECF in the TC (by good dispersion is meant that the ECF is broken down towards individual particles and usually is uniformly dispersed in the TC), and the inherent electrical conductivity of the ECF itself. It is usually desirable to minimize the concentration of the ECF in the TC because the ECF often deleteriously affects other properties, especially toughness and/or surface quality, and/or the ECF is often expensive. The degree of dispersion or other similar factors may be controlled to some extent by the procedure for forming the TC by melt mixing of the various ingredients (see below).

Other ingredients may also be present in the first composition, particularly those that are commonly added to thermoplastic compositions. Such ingredients include antioxidants, pigments, fillers, lubricant, mold release, flame retardants, (paint) adhesion promoters, epoxy compounds, crystallization nucleation agents, plasticizers, etc. Other polymers such as polyolefins, polyamides, and amorphous polymers such as polycarbonates, styrene (co)polymers and poly(phenylene oxides) may also be present. Preferably the total of all these ingredients is less than about 60 weight percent, very preferably less than about 40 weight percent, more preferably less than about 25 weight percent of the total composition. If any of these materials is a solid particulate material, it is preferred that the average longest dimensions of the particles is about 20 μm or less, more preferably about 15 μm or less. A preferred other ingredient is a plasticizer for the IPE, particularly when PET is present as an IPE, preferably present in an amount of about 0.5 to about 8 weight percent of total composition.

Another way of classifying “other ingredients” in the first composition is whether these ingredients contain functional groups which readily react (particularly under mixing conditions) with the functional groups of the polymeric toughening agent, component D. Ingredients, particularly “other ingredients” containing complimentary reactive functional groups, are termed “active ingredients” (or “inactive ingredients” if they don't contain such reactive groups) herein. The Table below gives a partial listing of “reactive groups” which may be part of Component D, together with complimentary reactive groups which may be part of active ingredients.

| Reactive Group | Complimentary Groups |
|---|---|
| epoxy | carboxyl, hydroxyl, amino |
| carboxylic anhydride | hydroxyl, amino |
| amino | carboxyl, hydroxyl, epoxy, chloro |
| isocyanato | carboxyl, hydroxyl, amino |
| hydroxyl | carboxyl, carboxylic anhydride, epoxy |
| chloro, bromo | amino |

Not included in active ingredients, and so are inactive ingredients, are polymers having a number average molecular weight of about 5,000 or more, preferably about 10,000 or more, and some or all of whose complimentary end groups may be reactive (with the functional groups of the polymeric toughener), and ECFs. Polymers having reactive groups which are not end groups, and which may or may not have reactive end groups, are active ingredients.

In one preferred type of composition less than 25 ppm, preferably less than 10 ppm (based on the IPE present) of “free” metal cations such as alkali metal or alkaline earth metal cations are added to the composition. By “free” metal cations are meant cations which may readily react with functional groups which are present in the composition, such as carboxyl groups to form carboxylate salts. Free metal cations may be added as carboxylate salts such as acetates or 4-hydroxybenzoates, as other metal salts such as metal halides, and as metal salts of polymeric carboxylates. Not included in added free metal cations are normal impurities in the other ingredients or metal cations which are part of minerals or other compounds, wherein the metal cations are tightly bound to that ingredient or mineral.

Another preferred ingredient is a lubricant, sometimes called a mold release or release agent. Typically about 0.05 to about 2.0 weight percent, preferably about 0.05 to about 1.0 weight percent (of the total composition) of lubricant is used. Many types of materials are sold as lubricants, and in the present compositions due regard should especially be given to their effects on mold release and paint adhesion (assuming the part is to be painted), as well as other physical properties. Lubricants may be active or inactive ingredients. For instance one type of preferred lubricant is polyethylene wax, a polyethylene usually having a number average molecular weight of about 1,000 to about 10,000. The end groups on these waxes may be nonpolar (for instance methyl ends), or may comprise polar groups, for instance carboxyl groups. The carboxyl ended waxes will, with polymeric tougheners having appropriate reactive groups, be considered reactive ingredients (when their molecular weights are below about 5000). Such waxes are commercially available, see for instance the Licowax® brand product line, available from Clariant Corp., Charlotte, N.C. 28205, USA. In some compositions inactive lubricants such as Licowax® PE 520 or PE 190 are preferred. However lubricants such as Licowax® PED 521 or PED 191, which are also active ingredients, can also be used.

The first compositions described herein can be made by typical melt mixing techniques. For instance the ingredients may be added to a single or twin screw extruder or a kneader and mixed in the normal manner. Preferably the temperature of the ingredients in at least part of the mixing apparatus is at or above the melting point of the LCP if present (the measured or set temperature in any zone of the mixing apparatus may be below the actual material temperature because of mechanical heating). Some of the ingredients such as fillers, plasticizers, crystallization nucleating agents, and lubricants (mold release) may be added at one or more downstream points in the extruder, so as to decrease attrition of solids such as fillers, and/or improve dispersion, and/or decrease the thermal history of relatively thermally unstable ingredients, and/or reduce loss of volatile ingredients by vaporization. After the materials are mixed they may be formed (cut) into pellets or other particles suitable for feeding to a melt forming machine. Melt forming can be carried out by the usual methods for thermoplastics, such as injection molding, thermoforming, extrusion, blow molding, or any combination of these methods.

When one or more “active ingredients” are present in the first composition, a particular variation of the above mixing procedure is preferred. In this variation, the IPE, optionally, and preferably, the LCP (if present), and polymeric toughening agent, and optionally additional inactive ingredients are mixed is a first mixing step, and any reactive ingredients and optionally inactive ingredients, as described above, are mixed into the intermediate composition containing the IPE in one or more subsequent mixing steps. This can be accomplished in a number of different ways. For instance, the first mixing step can be carried out in a single pass thorough a single or twin screw extruder or other type of mixing apparatus, and then the other ingredients are added during a second pass through a single or twin screw extruder or other mixing apparatus. Alternatively, the first mixing step is carried out in the “back end” (feed end) of a single or twin screw extruder or similar device and then the materials to be added for the second mixing step are added somewhere downstream to the barrel of the extruder, thereby mixing in the materials for the second mixing step. The added materials for the second mixing step may be added by a so-called “side feeder” or “vertical feeder” and/or if liquid by a melt pump. More than one side feeder may be used to introduce different ingredients. As noted above it may be preferable to add inactive ingredients in side and/or vertical feeders for other reasons. The use of an extruder with one or more side and/or vertical feeders is a preferred method of carrying out the first and second mixing steps. If an inactive lubricant is used, it is also preferred that it be added in the second mixing step. If two or more mixing passes are done, the machine(s) for these passes may be the same or different (types).

It will be understood that in making the first composition addition of the carbon black and active ingredients can be done in second or later mixing steps, so that each of these types of ingredients are added in an “optimum” manner. Indeed in some instances the carbon black can be present in a mixture also containing one or more of the active (and inactive) ingredients, and optionally the reinforcing filler, and added at the same time.

It has also been found that the mixing intensity [for example as measured by extruder speed (rpm)] may affect the properties of these compositions, especially toughness. While relatively higher rpm are preferred, the toughness may decrease at too high a mixer rotor speed. The optimum mixing intensity depends on the configuration of the mixer, the temperatures, compositions, etc. being mixed, and is readily determined by simple experimentation.

There are also preferred processes [“second” process(es) herein] of adding ECFs, particularly carbon blacks. In adding a carbon black to the composition it may be preferred that the carbon black (which is generally not a reinforcing filler since its primary particles tend to be spherical) be mixed intimately with (at least with part of) the reinforcing filler, especially wollastonite, and that this mixture (or a mixture comprising these two components) be fed into a molten stream of at least a substantial portion of the IPE in the final composition. Preferably after the carbon black is fed into the mixing machine (for instance twin screw extruder) it is subjected only to moderate mixing forces, not intensive mixing forces for two reasons. Intensive mixing forces tend to raise the temperature of the composition greatly when carbon black is present, sometimes resulting in overheating of the IPE or other materials. Intensive mixing may also reduce the aspect ratio of the reinforcing filler (if present) too much to so that the final composition does not have the desired properties.

This desired second (mixing) process for carbon black containing compositions may be accomplished in a variety of ways. The carbon black may be side fed to a twin screw extruder or other similar mixer in the second (or later) mixing step of the first process, as described above. The carbon black, optionally in a mixture with the F/RA, may also contain the other ingredients which are to be mixed into the composition in the second (or later) mixing step of the first process, again as described above. Alternately, the carbon black may be side fed to a single or twin screw extruder into the molten IPE at a concentration of carbon black substantially above the concentration required in the final composition. This composition comprising the IPE carbon black, and optionally other ingredients, is then pelletized and fed into the second mixing step of the first process described above. For example these pellets may be side fed into the process stream in a twin screw extruder. The first mixing step in this first process still mixes the remaining IPE that not used to make the IPE/carbon black mixture), polymeric toughening agent, and any other appropriate ingredients, and the second (and later) mixing step is as described above. In all cases it is preferred that compositions containing the carbon black not be subject to very intensive mixing conditions, such as those that may be found in the first mixing step of the first process.

The first composition, particularly when made by the first process, preferably has a surface resistivity of about 10¹² ohm/sq or less, more preferably 10⁹ ohm/sq or less, and especially preferably about 10⁷ ohm/sq or less. Herein surface resistivity is measured using ASTM Method D-257-93. The first composition, particularly when made by the first process, preferably has a volume resistivity of about 10¹² ohm/sq or less, more preferably 10⁹ ohm-cm or less, and especially preferably about 10⁷ ohm-cm or less. Herein volume resistivity is measured using ASTM Method D-257-93.

Alternatively, the first composition may have a static dissipative time of 10 seconds or less, preferably 5 seconds o or less, more preferably 3 seconds or less, and especially preferably 1 second or less. Compositions that have such static dissipative times typically have surface resistivities of 10¹² ohm/sq or less also, so the compositions may have both the desired static dissipative time and surface resistivity. For the method of measuring static dissipative times see below.

An intimate mixture of reinforcing filler and carbon black (or F/RA and carbon black, see below) may be formed simply by tumbling (or other similar method) these two ingredients together. If other materials are to be present in this mixture, they two may be tumbled together (if they are solids), or if liquids the solids may be absorbed or adsorbed on the solids present. By “intimate mixture” therefore is meant a uniform blend of the carbon black and reinforcing filler or F/RA.

Aside from the first composition herein, which is particularly useful for appearance parts where a smooth surface is important, electrically conductive (second) compositions which contain a thermoplastic (TP) and in which carbon black is the ECF, and which are otherwise useful, can also be made by variations of the second process described above. Instead of the reinforcing filler of the first composition the carbon black may first be intimately mixed with any filler or reinforcing agent (F/RA) such as talc, calcium sulfate, glass (sized or unsized) such as glass fiber, milled glass, and glass spheres, wollastonite, quartz, aramid fiber, TiO₂, silica, clay, bentonite, and mica, to form an intimate mixture. Preferably the F/RA is a material that has a Mohs hardness of 4 or more, and/or has an average aspect ratio (see above) of about 2.0 or more, more preferably about 4.0 or more, and/or is inorganic. If a smooth surface is important, the F/RA has an average longest particle dimension of about 20 μm or less, preferably about 10 μm or less. Particle size and aspect ratio are measured as described above for the first composition herein.

One of the useful ways of feeding the ECF, especially carbon black, to the melt mixer is as an intimate mixture with the F/RA, or at least part of the F/RA. The weight ratio of reinforcing filler of the first composition, or in the first or second processes, in the intimate mixture of this material with the carbon black that is fed to the mixer is preferably 0.1 or more, especially preferably about 0.5 or more (0.5 or more parts of reinforcing filler or F/RA to 1 part of carbon black), more preferably about 1.0 or more. Generally speaking, because of its fluffy nature, carbon black by itself is difficult to meter into a TP melt mixing device, and is often added as a masterbatch or some other mixture. By mixing with a substantial amount of reinforcing filler or F/RA in many instances it handles more easily and is more easily fed to the mixer, for example a side feeder for a twin screw extruder. By feeding the carbon black in this way, it is believed that at any given level of carbon black, but especially low levels where the electrical conductivity of the resulting composition varies greatly with small changes in carbon black concentration, relatively higher electrical conductivities are obtained, often more reproducibly.

To make the first composition it is not necessary to add the carbon black to the molten polymer in an intimate mixture with the reinforcing filler (first process) or F/RA (second process). The carbon black may merely be added by itself or with one or more other ingredients. In the case of the second process, therefore, in this case an F/RA may not be present.

It is preferred that a product of the second process has a surface resistivity of about 10¹² ohm/sq or less, more preferably 10⁹ ohm/sq or less, and especially preferably about 10⁷ ohm/sq or less. These are measured in the same manner as for the first composition. This product preferably has a volume resistivity of about 10¹² ohm/sq or less, more preferably 10⁹ ohm-cm or less, and especially preferably about 10⁷ ohm-cm or less. These are measured in the same manner as for the first composition.

Alternatively, the product of the second process may have a static dissipative time of 10 seconds or less, preferably 5 seconds or less, more preferably 3 seconds or less, and especially preferably 1 second or less. Compositions that have such static dissipative times typically have surface resistivities of 1012 ohm/sq or less also, so the compositions may have both the desired static dissipative time and surface resistivity.

The first composition described herein is particularly useful as “appearance parts”, that is parts in which the surface appearance is important, usually because the surface is visible to the consumer or ultimate user. This is applicable whether the composition's surface is viewed directly, or whether it is coated with paint or another material such as a metal. Such parts include automotive body panels such as fenders, fascia, hoods, tank flaps and other exterior parts; interior automotive panels; appliance parts such as handles, control panels, chassises (cases), washing machine tubs and exterior parts, interior or exterior refrigerator panels, and dishwasher front or interior panels; power tool housings such as drills and saws; electronic cabinets and housings such as personal computer housings, printer housings, peripheral housings, server housings; exterior and interior panels for vehicles such as trains, tractors, lawn mower decks, trucks, snowmobiles, aircraft, and ships; decorative interior panels for buildings; furniture such as office and/or home chairs and tables; and telephones and other telephone equipment. As mentioned above these parts may be painted or they may be left unpainted in the color of the composition. The composition may be colored with pigments, so many color variations are possible.

Automotive body panels are an especially challenging application. As mentioned above, these materials should preferably have smooth and reproducible appearance surfaces, be heat resistant so they can pass through without significant distortion automotive E-coat and paint ovens where temperatures may reach as high as about 200° C. for up to 30 minutes for each step, be tough enough to resist denting or other mechanical damage from minor impacts. It has been particularly difficult to obtain compositions which have good toughness yet retain good heat resistance and excellent surface appearance, because generally speaking when one of the properties is improved, another deteriorates. In the present composition, good heat resistance and good toughness may be achieved, as illustrated in some of the Examples herein.

The thermoplastic compositions described herein, and especially when they are to be coated (painted) in particular for automotive applications, may be pretreated in a conventional manner, for example, by UV irradiation, flame treatment or plasma treatment or be coated with a conventional plastic primer known to the person skilled in the art.

Particularly for a car body, the metal parts and the at least one thermoplastic part optionally provided with a plastic primer are assembled in the conventional manner known to the person skilled in the art, for example by screwing, clipping and/or adhesion, to form the substrate to be coated by the third process according to the invention.

At least that (those) plastic part(s) of a substrate with the smallest possible joint width and in particular also in the same plane as the adjacent metal parts is (are) assembled with the metal parts.

Optionally, unassembled plastic parts, if any, which in general may differ in composition from the at least one of the thermoplastic parts and which in general are less resistant to heat deformation can be fitted on after completion of step (1) of the process according to the invention and can also be subjected to the further coating process of step (2) (compare the in-line process described above) and/or be fitted on after completion of the process according to the invention in finished coated form (compare the off-line process described above).

In view of the application of at least one further coating layer, taking place in step (2) of the third process according to the invention, preferably by electrostatically-assisted spray coating, it is expedient if the metal and plastic part(s) are assembled such that that they are not electrically insulated from one another; for example a direct electric contact between the electrically conductive thermoplastic and metal can be ensured by direct contact or via electrically conductive connecting elements, for example metal screws.

To produce an anti-corrosive primer layer on the metal parts, the substrates assembled from metal parts and at least one thermoplastic part (especially the first composition) in step (1) of the third process according to the invention are coated in an electrodeposition coating bath in the conventional manner known to the person skilled in the art. Suitable electrodeposition coating agents include conventional waterborne coating compositions with a solids content from, for example, 10 to 30 wt. %. Preferably the resistivity of the thermoplastic part(s) in the first step of the third process is not so low that the electrodeposition coating also coats the thermoplastic. In other words it is preferred that in an assembly containing both thermoplastic and metal parts only the metal parts are coated in the first step of the third process.

The electrodeposition coating compositions may be conventional anodic electrodeposition coating agents known to the skilled person. The binder basis of the anodic electrodeposition coating compositions may be chosen at will. Examples of anodic electrodeposition binders are polyesters, epoxy resin esters, (meth)acrylic copolymer resins, maleinate oils or polybutadiene oils with a weight average molecular mass (Mw) of, for example, 300-10 000 and a carboxyl group content, for example, corresponding to an acid value of 35 to 300 mg KOH/g. At least a part of the carboxyl groups is converted to carboxylate groups by neutralization with bases. These binders may be self cross-linking or cross-linked with separate cross-linking agents.

Preferably conventional cathodic electrodeposition coating agents known to the skilled person are used in the process according to the invention for the application of the electrodeposition coating layer. Cathodic electrodeposition coating compositions contain binders with cationic groups or groups which can be converted to cationic groups, for example, basic groups. Examples include amino, ammonium, e.g., quaternary ammonium, phosphonium and/or sulfonium groups. Nitrogen-containing basic groups are preferred; said groups may be present in the quaternized form or they are converted to cationic groups with a conventional neutralizing agent, e.g., an organic monocarboxylic acid such as, e.g., formic acid, lactic acid, methane sulfonic acid or acetic acid. Examples of basic resins are those with primary, secondary and/or tertiary amino groups corresponding to an amine value from, for example, 20 to 200 mg KOH/g. The weight average molecular mass (Mw) of the binders is preferably 300 to 10,000. Examples of such binders are amino(meth)acrylic resins, aminoepoxy resins, aminoepoxy resins with terminal double bonds, aminoepoxy resins with primary OH groups, aminopolyurethane resins, amino group-containing polybutadiene resins or modified epoxy resin-carbon dioxide-amine reaction products. These binders may be self-cross-linking or they may be used with known cross-linking agents in the mixture. Examples of such cross-linking agents include aminoplastic resins, blocked polyisocyanates, cross-linking agents with terminal double bonds, polyepoxy compounds or cross-linking agents containing groups capable of transesterification.

Apart from binders and any separate cross-linking agents, the electrodeposition coating compositions may contain pigments, fillers and/or conventional coating additives. Examples of suitable pigments include conventional inorganic and/or organic colored pigments and/or fillers, such as carbon black, titanium dioxide, iron oxide pigments, phthalocyanine pigments, quinacridone pigments, kaolin, talc or silicon dioxide. Examples of additives include, in particular, wetting agents, neutralizing agents, leveling agents, catalysts, corrosion inhibitors, anti-cratering agents, anti-foaming agents, solvents.

Electrodeposition coating can take place in a conventional manner known to the skilled person, for example, at deposition voltages from about 200 to about 500 V. After deposition of the electrodeposition coating, the substrate is cleaned from excess and adhering but non-deposited electrodeposition coating in a conventional manner known to the skilled person, for example, by rinsing with water. Thereafter the substrate is baked at oven temperatures of, for example, up to about 220° C. according to object temperatures of, for example, up to about 200° C. in order to crosslink the electrodeposition coating.

In the subsequent step (2) of the process according to the invention, at least one further coating layer is applied, preferably by spray application, in particular electrostatically-assisted spray application, at least to all the visible metal and plastic surfaces on the substrates thus obtained and only provided with a baked electrodeposition coating layer on the metal surfaces.

If only one further coating layer is applied, this is generally a pigmented top coat. However, it is preferred to apply more than one further coating layer. Examples of conventional multicoat constructions formed from a plurality of coating layers are:
primer surfacer/top coat.
primer surfacer/base coat/clear coat,
base coat/clear coat,
primer surfacer substitute layer/base coat/clear coat.

Primer surfacers or primer surfacer substitute coatings are mainly used for stone-chip protection and surface leveling and prepare the surface for the subsequent decorative top coat which provides protection against environmental influences and is made of pigmented top coat or of color- and/or effect-producing base coat and protective clear coat.

The multicoat constructions mentioned by way of example may also be provided over the entire surface or part of the surface with a transparent sealing coat, in particular providing high scratch-resistance.

All these coating layers following the electrodeposition coating layer may be applied from conventional coating agents well known to the person skilled in the art for applying the relevant coating layer. This can be a respective liquid coating agent containing, for example, water and/or organic solvents as diluents or a powder coating agent. The coating agents may be a single-component or multi-component coating agent; they may be physically drying or by oxidation or be chemically crosslinkable. In particular, primer surfacers, top coats, clear coats and sealing coats these are generally chemically cross-linking systems which can be cured thermally (by convection and/or by infrared irradiation) and/or by the action of energy-rich radiation, in particular ultraviolet radiation. It is preferred that one or more (preferably all the) coating layers formed after the electrodeposition coating layer is applied are applied using an electrostatically assisted coating process.

If more than one coating layer is applied in step (2) of the process according to the invention, the coating layers do not basically have to be cured separately prior to application of the respective subsequent coating layer. Rather, the coating layer can be applied according to the wet-on-wet principle known to the person skilled in the art, wherein at least two coating layers are cured together. In particular, for example, in the case of base coat and clear coat, following the application of the base coat, optionally followed by a short flash-off phase, the clear coat is applied and cured together with the base coat.

The on-line process according to the invention allows substrates assembled in a mixed construction from metal parts and thermoplastic parts and are adequately resistant to heat deformation to be coated with excellent harmonization of the visual impression of the coated plastic and metal surfaces.

Heat resistance is commonly measured for this use by a heat sag test. In this test sample, which is suspended in a cantilever fashion, is heated to a test temperature for a given amount of time, and the amount the part has sagged is measured after cooling to room temperature. The lower the value, the better the heat sag. In the first composition, improved (lowered) heat sag is favored by a higher melting point of the IPE and/or LCP, lower toughener content, higher LCP content and higher reinforcing filler content. On the other hand toughness is improved (raised) by higher toughener content, lower reinforcing filler content, lower LCP content, higher functional group content in the toughener (within limits). As mentioned above the first composition often gives wide latitude to obtaining a material which has the requisite properties for an automotive body panel or other parts.

Surface quality can be judged by a variety of methods. One is simply visual, observing the smoothness and the reflectivity of the surface, and how accurately it reflects its surroundings. Another more systematic method is DOI. It is preferred that the appearance surfaces (those that need to be smooth, etc.) have a DOI of about 65 or more, more preferably about 70 or more, when measured using the AutoSpect® Paint Appearance Quality Measurement system. It is understood by the artisan that factors other than the composition itself can affect the surface quality of a part produced. For example the condition (porosity, flatness) of the mold surface, molding conditions such as fill time and fill pressure, mold design such as gate location and thickness of the part, mold and melt temperatures, and other factors can affect surface quality. If painted, the surface quality also depends on the painting technique used and the quality of the paint which is applied.

### Test Methods

Sag test A standard ASTM 20.3 cm (8″) long, 0.32 cm (⅛″) thick, tensile bar is clamped horizontally at one end in a cantilever fashion in a metal holder so that bar has a 15.2 cm (6″) over hang from the clamp. The bar in the holder is heated in a 200° C. for 30 min, and the distance (in mm) the end of the bar has sagged downward is measured after cooling to room temperature.

Instrument Impact Test This test measures the force vs. time as a weighted 1.27 cm (½″) diameter hemispherical tipped tup weighing 7.3 kg (16 lb) is dropped from 1.09 m through a 0.32 cm (⅛″) thick molded plaque. This gives a nominal tup speed of 4.5 m/sec when striking the plaque. The plaque is clamped on the top and bottom surfaces, both sides of the clamp having colinear 3.81 cm (1.5″) diameter holes, and the tup strikes the plaque in the center of these holes. An accelerometer is attached to the tup and the force during the impact is recorded digitally. The maximum (peak) force and total energy to break are calculated from the data. The data reported are the average of three determinations.

Tensile modulus, strength and elongation Measured using ASTM Method D256 at an extension rate of 5.08 cm (2″) per minute, using a Type I bar.

Flexural modulus (three point) Measured using ASTM Method D790.

Melting point Determined by ASTM D3418-82, at a heating rate of 10° C./min. The peak of the melting endotherm is taken as the melting point. Melting points of LCPs are taken on the second heat.

Surface and volume resistivities Measured using D-257-93. Surface resistivities were measured without a ground plane, and volume resistivities were measured without a guard ring.

Static dissipative time An ETS (Equipment for Technology and Science Inc., San Jose, Calif. 95119, USA) model 406C instrument applies a 5 kV charge to a plaque of the composition; an Electrostatic Voltmeter is used to measure this charge level. The sample is then grounded. The time (in seconds) that is required to discharge the material to 10% of the applied voltage is defined as the static decay time. Times of 0.01 second are indicative of 0.01 second or less. Measurements were made at 20% Relative Humidity and 22.2° C. (72° F.). Each sample was tested three times and the average of the three tests are reported (in seconds).

Paint conductivity Measured using a Devilbiss Ransburg conductivity meter (P/N-8333-00), taking readings at three different places on the unpainted panel being measured and averaging the results. The meter reads from 65 to 165 in arbitrary units, and a reading of about 90 or more, preferably about 110 or more, (these are sometimes called “Ransburg units”, see for instance U.S. Pat. No. 5,686,186) is considered adequate for electrostatic coating, and higher readings are better. A “+” on the reading means that the meter needle was up against the maximum peg (stop). This test measures the suitability of a substrate for electrostatic painting, not the conductivity of the paint itself.

Compounding and Molding Methods “Side fed” means those ingredients were mixed and fed in the side of the extruder, while “rear fed” means those ingredients were mixed and fed into the rear of the extruder. The mixing of the ingredients was usually by tumble mixing. In all cases the melt temperatures in the extruder were kept down by using less severe mixing screws than would have been used if carbon black was not present.

Compounding Method A Polymeric compositions were prepared by compounding in 30 mm Werner and Pfleiderer twin screw extruder. All ingredients were blended together and added to the rear (barrel 1) of the extruder except that Nyglos® and other minerals (including carbon black) were side-fed into barrel 5 (of 10 barrels) and the plasticizer was added using a liquid injection pump. Any exceptions to this method are noted in the examples. Barrel temperatures were set at 280-310° C. resulting in melt temperatures 290-350° C. depending on the composition and extruder rate and rpm of the screw.

Compounding Method B This was the same as Method A except a 40 mm Werner and Pfleiderer twin screw extruder was used. The side-fed materials were fed into barrel 6 (of 10 barrels).

Resins were molded into ASTM test specimens on a 3 or 6 oz injection molding machine. Melt temperature were 280-300° C., mold temperatures were 110-130° C.

In the Examples certain ingredients are used, and they are defined below:
CB1—see Ketjenblack® EC600JD
Crystar® 3934—PET homopolymer, IV=0.67, available from E. I. DuPont de Nemours & Co., Inc., Wilmington, Del. 19898 USA
Irganox® 1010—antioxidant available from Ciba Specialty Chemicals, Tarrytown, N.Y. 10591, USA.
Jetfil® 575C—talc from Luzenac America, Englewood, Colo. 80112 USA
Ketjenblack® EC600JD—conductive carbon black from Akzo Nobel Polymer Chemicals, LLC, Chicago, Ill. 60607 USA
L135 Mica—from Oglebay Norton Co., Cleveland, Ohio 44114 USA
LCP5—50/50/70/30/320 (molar parts) hydroquinone/4,4′-biphenol/terephthalic acid/2,6-napthalene dicarboxylic acid/4-hydroxybenzoic acid copolymer, melting point 334° C.
Licowax® PE 520—a polyethylene wax used as a mold lubricant available from Clariant Corp. Charlotte, N.C. 28205, USA. It is reported to have an acid value of 0 mg KOH/g wax.
Nyglos® 4—average approximately 9 μm length wollastonite fibers with no sizing available from Nyco Minerals, Calgary, AB, Canada.
OCF® 739—fiberglass from Owens-Corning Corp., Toledo, Ohio, USA
Omycarb® 15—calcium carbonate from OMYA, Inc., Alpharetta, Ga. 30022 USA
Plasthall® 809—polyethylene glycol 400 di-2-ethylhexanoate.
Polymer D—ethylene/n-butyl acrylate/glycidyl methacrylate (66/22/12 wt. %) copolymer, melt index 8 g/10 min.
PPG® 3563—glass fiber from PPG, Inc., Pittsburgh Pa. 15272, USA
Suzerite HK mica—from Zemex Industrial Minerals, Atlanta, Ga. 30338, USA
Vansil® HR 325—wollastonite from R. T. Vanderbilt Co., Norwalk, Conn. 06850, USA

In the Examples, all compositional amounts shown are parts by weight.

### EXAMPLES 1-9

Samples were mixed by Method A and molded by the standard injection molding procedure. Results are given in Table 1. Barrel temperatures were 300-310° C., except for Example 1 which was 280° C.

### EXAMPLES 10-13

Samples were mixed by Method B and molded by the standard injection molding procedure. Results are given in Table 2. The extruder screws were run at 250 rpm.

### EXAMPLES 14-20

Samples were mixed by Method A and molded by the standard injection molding procedure. Results are given in Table 3. The extruder screws were run at 250 rpm.

### EXAMPLES 21-27

Samples were mixed by Method A and molded by the standard injection molding procedure. Results are given in Table 4. The extruder screws were run at 300 rpm. All samples contained 3.48 wt. percent of Ketjenblack® EC600JD.

### EXAMPLES 28-39

Samples were mixed by Method A and molded by the standard injection molding procedure. Results are given in Table 5. The extruder screws were run at 300 rpm.

### EXAMPLES 40-47

Samples were mixed by Method A and molded by the standard injection molding procedure. There were two separate side feeding points at barrel 5 and 8. These are noted in Table 6. Results are given in Table 6. The extruder screws were run at 300 rpm.

TABLE 1

| | Example | | | | | | | | |
|---|---|---|---|---|---|---|---|---|---|
| | 1 | 2 | 3 | 4 | 5 | 6 | 7 | 8 | 9 |
| Rear Fed | | | | | | | | | |
| Crystar ® 3934 | 80.0 | 26.2 | 21.7 | 19.7 | 17.2 | 22.7 | 23.2 | 27.2 | 23.2 |
| Product of Ex. 1 | | 50 | 50 | 50 | 50 | | | | 16 |
| LCP5 | | 5.0 | 5 | 5 | 5 | 5 | 5 | 5 | 5 |
| Polymer D | | 15.0 | 15 | 12.5 | 15 | 12.5 | 12.5 | 12.5 | 12.5 |
| Irganox ® 1010 | | 0.3 | 0.3 | 0.3 | 0.3 | 0.3 | 0.3 | 0.3 | 0.3 |
| Licowax ® PE 520 | | 0.5 | 0.5 | 0.5 | 0.5 | 0.5 | | 0.5 | |
| Side Fed | | | | | | | | | |
| CB1 | 7.4 | | | | | | | | |
| Nyglos ® 4 | 12.6 | 0 | 4.5 | 9 | 9 | 9 | 9 | 4.5 | 9 |
| Product of Ex. 1 | | | | | | 47 | 47 | 47 | 31.0 |
| Injected | | | | | | | | | |
| Plasthall ® 809 | 0 | 3 | 3 | 3 | 3 | 3 | 3 | 3 | 3 |
| Total | 100 | 100 | 100 | 100 | 100 | 100 | 100 | 100 | 100 |
| Barrel Temperature, ° C. | 280 | 310 | 310 | | 310 | 300 | 300 | 300 | 300 |
| Final formulation amounts | | | | | | | | | |
| CB1 | | 3.7 | 3.7 | 3.7 | 3.7 | 3.5 | 3.5 | 3.5 | 3.5 |
| Nyglos ® 4 | | 6.3 | 10.8 | 15.3 | 15.3 | 14.9 | 14.9 | 10.4 | 14.9 |
| Sag, 200° C., mm as molded | | 24.41 | 22.17 | 19.79 | 19.14 | 17.09 | 12.93 | 19.18 | 15.19 |
| Tensile strength, MPa | | 41.9 | 41.5 | 45.1 | 40.9 | 45.6 | 45.1 | 42.5 | 45.2 |
| Tensile elongation to break, % | | 41.97 | 31.22 | 15.79 | 18.89 | 10.9 | 13.48 | 19.75 | 17.71 |
| Flex modulus, GPa | | 2.32 | 2.44 | 2.87 | 2.45 | 3.32 | 3.27 | 2.79 | 3.04 |
| Instrumented impact, J | | 30.57 | 17.10 | 11.00 | 14.64 | 7.30 | 5.83 | 6.47 | 10.67 |
| Peak force, N | | 4524 | 3572 | 1810 | 1784 | 1383 | 1450 | 1695 | 2438 |
| Resistivity, volume (ohm-cm) | 1.69E+04 | 2.44E+14 | 1.16E+11 | 1.17E+10 | 1.19E+12 | 1.77E+07 | 1.49E+07 | 5.12E+07 | 2.75E+08 |
| Resistivity, surface (ohm/sq) | 1.74E+03 | 2.89E+12 | 1.06E+12 | 7.20E+10 | 7.12E+11 | 7.82E+05 | 7.92E+05 | 4.72E+06 | 7.36E+07 |
| Paint conductivity | | 80 | 79 | 79 | 79 | 79 | 160 | 146 | 133 |

TABLE 2

| | Example | | | |
|---|---|---|---|---|
| | 10 | 11 | 12 | 13 |
| Rear Fed | | | | |
| Crystar ® 3934 | 66.7 | 71.7 | 66.7 | 66.7 |
| LCP5 | 5 | 0 | 5 | 5 |
| Polymer D | 15 | 15 | 15 | 15 |
| Irganox ® 1010 | 0.3 | 0.3 | 0.3 | 0.3 |
| Side Fed | | | | |
| CB1 | 3.5 | 3.5 | 3.5 | 3.5 |
| Nyglos ® 4 | 6 | 6 | 6 | 6 |
| Licowax ® PE 520 | 0.5 | 0.5 | 0.5 | 0.5 |
| Injected | | | | |
| Plasthall ® 809 | 3 | 3 | 3 | 3 |
| Total | 100 | 100 | 100 | 100 |
| Final formulation | | | | |
| amounts | | | | |
| Nyglos ® 4 | 6 | 6 | 5.37 | 4.74 |
| CB1 | 3.5 | 3.5 | 3.13 | 2.76 |
| Sag, 200° C., mm, as | 22.63 | 21.3 | 22.25 | 24.08 |
| molded | | | | |
| Tensile strength, MPa | 41.3 | 42.5 | 40.9 | 40.1 |
| Tensile elongation to | 48.05 | 51.24 | 49.93 | 54.64 |
| break, % | | | | |
| Flex modulus, GPa | 2.40 | 2.47 | 2.44 | 2.37 |
| Instrumented impact, J | 24.29 | 27.1 | 32.37 | 32.98 |
| Peak force, N | 4408 | 4502 | 4573 | 4457 |
| Resistivity, volume | 1.28E+07 | 1.14E+07 | 3.60E+08 | 2.06E+11 |
| (ohm-cm) | | | | |
| Resistivity, surface | 2.29E+05 | 9.20E+05 | 4.75E+07 | 1.15E+08 |
| (ohm/sq) | | | | |
| Paint conductivity | 165+ | 165+ | 129 | 80 |

TABLE 3

| | Example | | | | | | |
|---|---|---|---|---|---|---|---|
| | 14 | 15 | 16 | 17 | 18 | 19 | 20 |
| Rear Fed | | | | | | | |
| Crystar ® 3934 | 66.7 | 71.7 | 67.7 | 76.2 | 65.95 | 63.45 | 60.2 |
| LCP5 | 5 | 0 | 5 | 5 | 5 | 5 | 5 |
| Licowax ® PE 520 | 0.5 | 0.5 | 0.5 | 0.5 | 0.5 | 0.5 | 0.5 |
| Polymer D | 15 | 15 | 15 | 15 | 13.75 | 13.75 | 12.5 |
| Irganox ® 1010 | 0.3 | 0.3 | 0.3 | 0.3 | 0.3 | 0.3 | 0.3 |
| Side Fed | | | | | | | |
| CB1/Nyglos 4 mixture (36.8/63.2 parts) | 9.5 | 9.5 | 8.5 | 7.5 | 9.5 | 9.5 | 9.5 |
| Nyglos ® 4 | | | | | 2 | 4.5 | 9 |
| Injected | | | | | | | |
| Plasthall ® 809 | 3 | 3 | 3 | 3 | 3 | 3 | 3 |
| Total | 100 | 100 | 100 | 100 | 100 | 100 | 100 |
| Final formulation amounts | | | | | | | |
| CB1 | 3.5 | 3.5 | 3.13 | 2.76 | 3.50 | 3.50 | 3.50 |
| Nyglos ® 4 | 6 | 6 | 5.37 | 4.74 | 8 | 10.5 | 15 |
| Sag, 200° C., mm, as molded | 21.02 | 22.55 | 22.19 | 25.59 | 22.74 | 17.11 | 14.48 |
| Instrumented Impact, J | 18.0 | 20.3 | 12.4 | 31.5 | 6.1 | 5.0 | 4.59 |
| Peak force, N | 3817 | 3910 | 3074 | 4439 | 1815 | 1370 | 2064 |
| Resistivity, volume (ohm-cm) | 1.73E+07 | 3.37E+06 | 1.63E+07 | 1.45E+11 | 2.21E+06 | 7.53E+04 | 1.12E+05 |
| Resistivity, surface (ohm/sq) | 2.19E+06 | 4.27E+05 | 8.89E+05 | 5.40E+11 | 2.47E+05 | 2.82E+04 | 1.57E+04 |

TABLE 4

| | Example | | | | | | |
|---|---|---|---|---|---|---|---|
| | 21 | 22 | 23 | 24 | 25 | 26 | 27 |
| Rear Fed | | | | | | | |
| Crystar ® 3934 | 67.5 | 67.5 | 67.5 | 67.5 | 67.5 | 67.5 | 67.5 |
| LCP5 | 5 | 5 | 5 | 5 | 5 | 5 | 5 |
| Polymer D | 15 | 15 | 15 | 15 | 15 | 15 | 15 |
| Irganox ® 1010 | 0.3 | 0.3 | 0.3 | 0.3 | 0.3 | 0.3 | 0.3 |
| Licowax ® PE 520 | 0.5 | 0.5 | 0.5 | 0.5 | 0.5 | 0.5 | 0.5 |
| Side Fed | | | | | | | |
| Ketjenblack ® EC600JD/VANSIL ® HR-325, | 8.7 | | | | | | |
| 40/60 blend | | | | | | | |
| KetjenBlack ® EC600JD/Omycarb ® 15, 40/60 blend | | 8.7 | | | | | |
| KetjenBlack ® EC600JD/Jetfil ® 575C, 40/60 blend | | | 8.7 | | | | |
| KetjenBlack ® EC600JD/PPG ® 3563, 40/60 blend | | | | 8.7 | | | |
| KetjenBlack ® EC600JD/OCF ® 739 40/60 blend | | | | | 8.7 | | |
| KetjenBlack ® EC600JD/suzerite HK Mica, | | | | | | 8.7 | |
| 40/60 blend | | | | | | | |
| KetjenBlack ® EC600JD/L135 Mica, | | | | | | | 8.7 |
| 40/60 blend | | | | | | | |
| Injected | | | | | | | |
| Plasthall ® 809 | 3 | 3 | 3 | 3 | 3 | 3 | 3 |
| Total | 100 | 100 | 100 | 100 | 100 | 100 | 100 |
| Resistivity, Surface (ohm/sq) | 1.41E+08 | 2.04E+05 | 1.24E+05 | 1.39E+04 | 3.01E+06 | 1.20E+07 | 2.09E+05 |

TABLE 5

| | Example | | | | | |
|---|---|---|---|---|---|---|
| | 28 | 29 | 30 | 31 | 32 | 33 |
| Rear Fed | | | | | | |
| Crastin ® 6130 | 70.2 | 65.2 | 70.0 | 65.0 | 69.8 | 64.8 |
| Licowax ® PE520 | 0.5 | 0.5 | 0.5 | 0.5 | 0.5 | 0.5 |
| LCP5 | | 5.0 | | 5.0 | | 5.0 |
| Polymer D | 15.0 | 15.0 | 15.0 | 15.0 | 15.0 | 15.0 |
| Irganox ® 1010 | 0.3 | 0.3 | 0.3 | 0.3 | 0.3 | 0.3 |
| Side Fed | | | | | | |
| CB1 | 2.0 | 2.0 | 2.2 | 2.2 | 2.4 | 2.4 |
| Nyglos ® 4 | 12.0 | 12.0 | 12.0 | 12.0 | 12.0 | 12.0 |
| Sag @ 200 C, mm | 19.82 | 19.78 | 21.07 | 22.8 | 24.64 | 29.69 |
| Tensile Strength, MPa | 47.5 | 46.3 | 47.5 | 45.8 | 46.6 | 45.9 |
| Tensile Elongation, % | 24.92 | 20.76 | 23.41 | 16.39 | 23.62 | 18.60 |
| Flex Modulus, GPa | 2.55 | 2.49 | 2.53 | 2.43 | 2.47 | 2.44 |
| Instrumented Impact, J | 31.5 | 17.0 | 28.6 | 14.6 | 35.2 | 17.7 |
| Peak Force, kg | 431 | 376 | 436 | 345 | 442 | 386 |
| Surface Resistivity | 2.26E+14 | 2.27E+12 | 2.36E+12 | 3.25E+12 | 2.29E+12 | 2.36E+12 |
| Static Dissipative Time, s | 0.03 | >99 | 0.01* | >99 | 0.01 | >99 |
| | Example | | | | | |
| | 34 | 35 | 36 | 37 | 38 | 39 |
| Rear Fed | | | | | | |
| Crastin ® 6130 | 68.7 | 63.7 | 68.2 | 63.2 | 65.7 | 60.7 |
| Licowax ® PE520 | 0.5 | 0.5 | 0.5 | 0.5 | 0.5 | 0.5 |
| LCP5 | | 5.0 | | 5.0 | | 5.0 |
| Polymer D | 15.0 | 15.0 | 15.0 | 15.0 | 15.0 | 15.0 |
| Irganox ® 1010 | 0.3 | 0.3 | 0.3 | 0.3 | 0.3 | 0.3 |
| Side Fed | | | | | | |
| CB1 | 3.5 | 3.5 | 4.0 | 4.0 | 3.5 | 3.5 |
| Nyglos ® 4 | 12.0 | 12.0 | 12.0 | 12.0 | 15.0 | 15.0 |
| Sag @ 200 C, mm | 22.53 | 25.66 | 26.37 | 24.5 | 23.37 | 22.74 |
| Tensile Strength, MPa | 46.7 | 43.9 | 42.4 | 43.6 | 46.0 | 45.0 |
| Tensile Elongation, % | 12.45 | 13.14 | 12.09 | 9.35 | 12.06 | 9.96 |
| Flex Modulus, GPa | 2.46 | 2.31 | 2.13 | 2.25 | 2.53 | 2.38 |
| Instrumented Impact, J | 10.9 | 8.8 | 9.0 | 8.0 | 8.0 | 9.4 |
| Peak Force, kg | 279 | 179 | 246 | 141 | 251 | 165 |
| Surface Resistivity | 2.11E+09 | 2.02E+11 | 1.18E+07 | 2.76E+06 | 5.10E+08 | 2.26E+08 |
| Static Dissipative Time, s | 0.01 | 0.01 | 0.01 | 0/01 | 0.01 | 0.01 |

*Full voltage of the instrument was required to charge to 5 kV.

TABLE 6

| | Example | | | | | | | |
|---|---|---|---|---|---|---|---|---|
| | 40 | 41 | 42 | 43 | 44 | 45 | 46 | 47 |
| Rear Fed | | | | | | | | |
| Crystar ® 3934 | 67.2 | 69.2 | 70.2 | 70.7 | 68.7 | 72.2 | 75.2 | 69.2 |
| Licowax ® PE520 | 0.5 | 0.5 | 0.5 | 0.5 | 0.5 | 0.5 | 0.5 | 0.5 |
| LCP5 | 2.5 | 2.5 | 2.5 | 2.5 | 2.5 | 2.5 | 2.5 | 2.5 |
| Polymer D | 15 | 15 | 15 | 15 | 15 | 15 | 15 | 15 |
| Irganox ® 1010 | 0.3 | 0.3 | 0.3 | 0.3 | 0.3 | 0.3 | 0.3 | 0.3 |
| Side Fed Barrel 5 | | | | | | | | |
| Nyglos ® 4 | 8.0 | 6.0 | 6.0 | 6.0 | 6.0 | 3.0 | 0.0 | 6.0 |
| CB1 | | | | | | | | 3.5 |
| Side Fed Barrel 8 | | | | | | | | |
| CB1 | 3.5 | 3.5 | 2.5 | 2.0 | 4.0 | 3.5 | 3.5 | |
| Injected | | | | | | | | |
| Plasthall ® 809 | 3.0 | 3.0 | 3.0 | 3.0 | 3.0 | 3.0 | 3.0 | 3.0 |
| Heat Sag @ 200° C., mm | 23.42 | 24.95 | 26.38 | 26.87 | 25.81 | 30.85 | 31.22 | 26.17 |
| Flex Modulus, GPa | 2.82 | 2.6 | 2.5 | 2.52 | 2.71 | 2.37 | 2.14 | 2.55 |
| Instrumented Impact, J | 16.95 | 30.97 | 42.3 | 47.33 | 16.18 | 45.48 | 52.1 | 20 |
| Peak Force, kg | 379 | 483 | 503 | 506 | 378 | 504 | 484 | 410 |
| Surface Resistivity | 1.23E+06 | 3.83E+06 | 7.93E+12 | 8.56E+12 | 1.15E+05 | 6.32E+08 | 2.91E+08 | 6.19E+04 |

1. A composition, comprising,
(a) at least about 40 weight percent of one or more isotropic polyesters with a melting point of about 100° C. or more;
(b) 0.0 to about 20 weight percent of a liquid crystalline polymer whose melting point is at least 50° C. higher than a cold crystallization point of said isotropic polyester, or if said isotropic polyester has no cold crystallization point said melting point of said liquid crystalline polymer is 150° C. or higher;
(c) about 1.0 to about 35 weight percent of a reinforcing agent with an average aspect ratio of about 2.5 or more, and whose average longest dimension is 20 μm or less;
(d) about 3 to about 30 weight percent of a polymeric toughening agent which contains functional groups reactive with said isotropic polyester; and
(e) a sufficient amount of an electrically conductive filler so that said composition has one or more of a surface resistivity of said composition is about 1012 ohm/sq or less, a static dissipative time of about 10 seconds or less, and a paint conductivity of about 90 or more, and wherein an average longest dimension of said electrically conductive filler is 20 μm or less;
and wherein all percents by weight are based on the total of all ingredients in the composition.

2. The composition as recited in claim 1 wherein said isotropic polyester has a melting point of about 200° C. or higher.

3. The composition as recited in claim 2 wherein said isotropic polyester is from one or more of terephthalic acid, isophthalic acid and 2,6-naphthalene dicarboxylic acid, and one or more of HO(CH₂)ₙOH, 1,4-cyclohexanedimethanol, HO(CH₂CH₂O)ₘCH₂CH₂OH, and HO(CH₂CH₂CH₂CH₂O)_{z}CH₂CH₂CH₂CH₂OH, wherein n is an integer of 2 to 10 μm is an average of 1 to 4, and is z an average of about 7 to about 40.

4. The composition as recited in claim 2 wherein said isotropic polyester is poly(ethylene terephthalate), poly(1,3-propylene terephthalate), poly(1,4-butylene terephthalate), poly(ethylene 2,6-napthoate), poly(1,4-cylohexyldimethylene terephthalate), or a thermoplastic elastomeric polyester having poly(1,4-butylene terephthalate) and poly(tetramethyleneether)glycol blocks.

5. The composition as recited in claim 2 wherein said reinforcing agent has an average maximum dimension of about 15 μm or less.

6. The composition as recited in claim 2 wherein said reinforcing agent is about 3 to about 20 weight percent of said composition.

7. The composition as recited in claim 2 wherein said reinforcing agent has an aspect ratio of about 3.0 or more.

8. The composition as recited in claim 2 wherein said reinforcing agent is wollastonite, talc or potassium titanate whiskers.

9. The composition as recited in claim 1 wherein about 1.0 to about, 10 weight percent of a liquid crystalline polymer is present.

10. The composition as recited in claim 1 wherein said functional groups are carboxylic anhydride or epoxy.

11. The composition as recited in claim 1 wherein said polymeric toughening agent is a copolymer comprising ethylene, and a functional (meth)acrylate monomer.

12. The composition as recited in claim 1 wherein said polymeric toughening agent contains about 0.5 to about 20 weight percent of monomers containing functional groups.

13. The composition as recited in claim 1 wherein said electrically conductive filler is carbon black.

14. The composition as recited in claim 1 which also comprises about 0.05 to about 2.0 weight percent of a lubricant.

15. The composition as recited in claim 1 which has one or more of said surface resistivity of about 109 ohm/sq or less, said static dissipative time of about 3 seconds or less, and a paint conductivity of about 110 or more.

16. The composition as recited in claim 1 wherein said isotropic polyester has a melting point of about 200° C. or more, said isotropic polyester is poly(ethylene terephthalate), poly(1,3-propylene terephthalate), poly(1,4-butylene terephthalate), poly(ethylene 2,6-napthoate), poly(1,4-cylohexyldimethylene terephthalate), or a thermoplastic elastomeric polyester having poly(1,4-butylene terephthalate) and poly(tetramethyleneether)glycol blocks, said reinforcing agent has an average maximum dimension of about 15 μm or less, said reinforcing agent is about 3 to about 20 weight percent of said composition, said functional groups are carboxylic anhydride or epoxy, said polymeric toughening agent is a copolymer comprising ethylene, and a functional (meth)acrylate monomer, and said electrically conductive filler is carbon black.

17. A process of coating the composition of claim 1 by electrostatic coating.

18. The product of the process of claim 17.

19. An appearance part comprising the composition of 5 claim 1.

20. The appearance part as recited in claim 19 which has been coated.

21. The appearance part as recited in claim 20 wherein said coating was applied by electrostatic coating.

22. The appearance part as recited in claim 21 which has a DOI of about 70 or more.

23. A car body comprising an appearance part of the composition of claim 1.

24. The car body as recited in claim 23 which has been coated.

25. The car body as recited in claim 24 wherein said coating was applied by electrostatic coating.

26. The car body as recited in claim 1 wherein a coated composition of claim 1 has a DOI of about 70 or more.

27. A process for the manufacture of a composition comprising:
(a) at least about 40 weight percent of one or more isotropic polyester (IPE) with a melting point (MP) of about 100° C. or more;
(b) 0.0 to about 20 weight percent of a liquid crystalline polymer (LCP) whose melting point is at least 50° C. higher than a cold crystallization point (CCP) of said isotropic polyester, or if said isotropic polyester has no cold crystallization point said melting point of said liquid crystalline polymer is 150° C. or higher;
(c) about 1.0 to about 35 weight percent of a reinforcing agent with an average aspect ratio of about 2.5 or more, and whose average longest dimension is 20 μm or less;
(d) about 3 to about 30 weight percent of a polymeric toughening agent which contains functional groups reactive with said isotropic polyester; and
(e) a sufficient amount of an electrically conductive filler so that said composition has one or more of a surface resistivity of said composition is about 10¹² ohm/sq or less, a static dissipative time of about 10 seconds or less, and a paint conductivity of about 90 or more, and wherein an average longest dimension of said electrically conductive filler is 20 μm or less;
and wherein all percents by weight are based on the total of all ingredients in the composition;
said process comprising the steps of:
(a) in a first mixing step mixing materials comprising said isotropic polyester and said polymeric toughening agent to form an intermediate composition; and then
(b) in a subsequent mixing step by introducing and mixing said carbon black, and optionally other ingredients, into said intermediate composition while said intermediate composition is molten.

28. The process as recited in claim 27 wherein said isotropic polyester has a melting point of about 200° C. or more, said isotropic polyester is poly(ethylene terephthalate), poly(1,3-propylene terephthalate), poly(1,4-butylene terephthalate), poly(ethylene 2,6-napthoate), poly(1,4-cylohexyldimethylene terephthalate), or a thermoplastic elastomeric polyester having poly(1,4-butylene terephthalate) and poly(tetramethyleneether)glycol blocks, said reinforcing agent has an average maximum dimension of about 15 μm or less, said reinforcing agent is about 3 to about 20 weight percent of said composition, said functional groups are carboxylic anhydride or epoxy, said polymeric toughening agent is a copolymer comprising ethylene, and a functional (meth)acrylate monomer, and said electrically conductive filler is carbon black.

29. The process as recited in claim 27 wherein said composition has one or more of said surface resistivity of about 109 ohm/sq or less, said static dissipative time of about 3 seconds or less, and a paint conductivity of about 110 or more.

30. A process for the manufacture of an electrically conducting thermoplastic composition, comprising, introducing and mixing carbon black into a material comprising a molten thermoplastic polymer, to form said thermoplastic composition.

31. The process as recited in claim 30 wherein said carbon black is introduced into said material as a mixture with a filler or reinforcing agent.

32. A process for coating a substrate assembled from metal parts and at least one plastic part, with visible metal and thermoplastic surfaces, comprising the successive steps:
(1) partially or completely electrodeposition coating the substrate, removing non-deposited electrodeposition coating agent from the substrate and thermally cross-linking the deposited electrodeposition coating and thereby forming an electrodeposition coating primer on the metal surfaces,
(2) application and curing of at least one additional coating at least on all the visible metal and thermoplastic surfaces,
wherein at least some of the thermoplastic parts making up the visible plastic surfaces of the substrate are of the composition of claim 1.

33. The process as recited in claim 32 wherein said application is electrostatically assisted.

34. The process as recited in claim 32 wherein in step (1) said thermoplastic surfaces are not coated.

35. The process as recited in claim 33 wherein said thermoplastic surfaces of the composition of claim 1 after coating have a DOI of about 70 or more.
